(19) United States
(12) Patent Application Publication
(10) Pub. No.: US 2023/0030959 A1
(43) Pub. Date: Feb. 2, 2023

(54) ELECTRODE AND ELECTROLYTE ADDITIVES FOR HIGH ENERGY LITHIUM-ION BATTERIES

(71) Applicant: UCHICAGO ARGONNE, LLC, Chicago, IL (US)

(72) Inventors: Jiayan Shi, Woodridge, IL (US); Khalil Amine, Woodridge, IL (US); Chi Cheung Su, Westmont, IL (US); Rachid Amine, Bolingbrook, IL (US)

(73) Assignee: UCHICAGO ARGONNE, LLC, Chicago, IL (US)

(21) Appl. No.: 17/389,762

(22) Filed: Jul. 30, 2021

(51) Int. Cl. H01M 4/58; H01M 4/583; H01M 4/485; H01M 4/38; H01M 4/36; H01M 10/0569; H01M 4/04

(52) U.S. Cl. CPC H01M 4/5815; H01M 4/583; H01M 4/485; H01M 4/387; H01M 4/364; H01M 10/0569; H01M 4/0402; H01M 2300/0042

(57) ABSTRACT

Methods of applying as-prepared alkaline source materials for a secondary battery. The cathode includes an alkaline source material with or without coating including an alkali metal oxide, an alkali metal sulfide, an alkali metal salt, or a combination of any two or more thereof. An as-prepared spread coating layer for a secondary battery, the coating layer includes an alkaline source material, including an alkali metal oxide, an alkali metal sulfide, and an alkali metal salt, with or without coating, a conductive carbon, a catalyst, or a combination of any two or more thereof. An as-prepared electrolyte for a secondary battery, the electrolyte includes an alkaline source material including an alkali metal oxide, an alkali metal sulfide, an alkali metal salt, or a combination of any two or more thereof.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to secondary batteries. More particularly, the technology is related to electroactive materials that include lithium or sodium with a coating of an alkaline source material.

### SUMMARY

In one aspect, a process is provided for the preparation of a carbon coating or impregnation of alkaline source materials into carbon to improve the chemical stability, structure stability, conductivity, and enhance the activation of alkaline source materials.

In one aspect, a process is provided for the preparation of a lithium-activated or sodium-activated alkaline source-carbon-catalyst composite material to form a layer on the surface of the cathode.

In one aspect, an electrolyte is provided. The liquid electrolyte includes alkaline source materials to form a pre-activation electrolyte; and charging the pre-activation electrolyte to a pre-determined voltage with or without elevated temperature.

In another aspect, an electrochemical device is provided including the cathode, alkaline source materials, electrolyte, and an anode including graphite, lithium metal, Sb, Si, Si—C, SiO, Sn, tin oxide, a composite tin or Si alloy, intermetallic compounds, a transition metal oxide, hard carbon soft carbon, graphite or a lithium metal nitride, phosphorous including black and red phosphorous, and phosphorous carbon composite; as well as doped phosphorus carbon with Sb, Si, Si—C, SiO, Sn, tin oxide, a composite tin alloy, a transition metal oxide, or a lithium metal nitride or a mixture of any two or more.

In another aspect, a process for coating an alkaline source material includes contacting the alkaline source material with a carbon source to form a carbon-coated alkaline source material. In some embodiments, the alkaline source material includes Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, or a mixture of any two or more thereof. In some embodiments, the carbon source is a conductive carbon source and the contacting comprises (a) mixing of the alkaline source material with the conductive carbon source in a solvent or (b) introducing a gaseous hydrocarbon to the alkaline source material at elevated temperature, wherein the elevated temperature is sufficient to decompose the gaseous hydrocarbon to carbon that is then deposited on and around the alkaline source material. In some embodiments, the contacting includes (a) and the conductive carbon source comprises carbon nanotubes, carbon fiber, microporous carbon, mesoporous carbon, macroporous carbon, mesoporous microbeads, graphite, expandable graphite, polymer yield carbon, or carbon black. In some embodiments, the contacting includes (b) and the gaseous hydrocarbon comprises ethylene, propylene, toluene, or a mixture of any two or more thereof, and the elevated temperature is from about 150° C. to about 1000° C. In some embodiments, the elevated temperature is from about 150° C. to about 450° C. In some embodiments, the contacting the alkaline source material with the carbon source further includes contacting with a catalyst. In some embodiments, the catalyst includes a transition metal oxide, a non-precious metal, a precious metal, a metal alloy, or a mixture of any two or more thereof. In some embodiments, the alkaline source material is Li₂O₂, Li₂O₂ with carbon nanotube, or Li₂O₂ with carbon nanotubes and an iron catalyst. In some embodiments, the alkaline source material is Li₂O₂, Li₂O, lithiated sulfur, or mixture of any two or more. In some embodiments, the alkaline source material is Li₂O₂. In some embodiments, the alkaline source material is present in the carbon-coated alkaline source material from about 0.1 wt % to about 99 wt %.

In another aspect, a process for coating a precursor of alkaline source material includes contacting the precursor with a carbon source to form a carbon-coated alkaline source material. In some embodiments, the precursor alkaline source material includes Li₂O₂, Na₂O₂, NaO₂, sulfur, selenium. In some embodiments, the precursor of alkaline source material is reduced by lithium containing reducing agent to form the alkaline source material. In some embodiments, the lithium containing reducing agent includes lithium, lithium polysulfides, lithium hydride, lithium borohydride, lithium aluminumhydride, alkyl lithium, aryl lithium.

In another aspect, a process for preparing a lithium-activated or sodium-activated cathode includes combining a cathode active material and a carbon-coated alkaline source material to form a pre-activation material; applying a charging voltage to the cathode, wherein the charging voltage is sufficient to activate the alkaline source material and form the lithium-activated or sodium-activated cathode; wherein the alkaline source material comprises lithium or sodium ions. In some embodiments, the alkaline source material includes Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, or a mixture of any two or more thereof. In some embodiments, the charging voltage is about 3 V to about 5 V vs. Li⁰. In some embodiments, the cathode active material includes a lithium-based carbon-coated olivine, LiFePO₄, LiCoO₂, LiNiO₂, LiNi₁₋ₓCo_{y}M⁴_{z}O₂, LiMn_{0.5}Ni_{0.5}O₂, Li₁₊ₓMn_{2-z}M⁴_{y}PO₄₋ₘX¹ₙ, LiFe_{1-z}M⁶_{y}PO₄₋ₘX¹ₙ, LiMn_{1/3}Co_{1/3}Ni_{1/3}O₂, LiMn₂O₄, LiFeO₂, LiM⁴_{0.5}Mn_{1.5}O₄, Li₁ₓ-Ni_{α}Mn_{β}Co_{γ}M⁵_{δ}O_{2-z″}, Li₂MnO₃-LiₐM_{b}M′_{c}M″_{d}Oₑ, Liₙ.B¹₂(M²O₄)₃ (Nasicon), Li₂MSiO₄, or a mixture of any two or more thereof, wherein M² is P, S, Si, W, or Mo; M⁴ is Al, Mg, Ti, B, Ga, Si, Ni, or Co; M⁵ is Mg, Zn, Al, Ga, B, Zr, or Ti; M⁶ is Al, Mg, Ti, B, Ga, Si, Ni, Mn or Co; A is Li, Ag, Cu, Na, Mn, Fe, Co, Ni, or Zn; M, M′, and M″ are transition metals; B¹ is Ti, V, Cr, Fe, or Zr; X¹ is S or F; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤α≤1; 0≤β≤1; 0≤y≤1; 0≤δ≤0.4; 0≤z″≤0.4; 0≤n′≤3; 0≤a+b+c+d≤6; 0≤e≤4; and 0≤α+β+γ+δ. In some embodiments, the cathode active material includes a sodium-based spinel, an sodium-based olivine, NaFePO₄, NaCoO₂, NaNiO₂, NaNi₁₋ₓCo_{y}M⁴_{z}O₂, NaMn_{0.5}Ni_{0.5}O₂, NaMn_{1/3}Co_{1/3}Ni_{1/3}O₂, NaMn₂O₄, NaFeO₂, NaM⁴_{0.5}Mn_{1.5}O₄, Na_{1+x″}Ni_{α}Mn_{β}Co_{γ}M⁵_{δ}O_{2-z″}F_{z}″, Na₂MnO₃-NaₐM_{b}M′_{c}M″_{d}Oₑ, Naₙ—B¹₂(M²O₄)₃ (Nasicon), Na₂MSiO₄, NaVPO₄F, or a mixture of any two or more thereof, wherein M² is P, S, Si, W, or Mo; M⁴ is Al, Mg, Ti, B, Ga, Si, Mn, or Co; M⁵ is Mg, Zn, Al, Ga, B, Zr, or Ti; M, M′, and M″ are transition metals; B¹ is Ti, V, Cr, Fe, or Zr; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤δ≤1; 0≤β≤1; 0≤γ≤1; 0≤δ≤1; 0≤δ′≤0.4; 0≤z″≤0.4; 0≤n′≤3; 0≤a+b+c+d, and 0<e. In some embodiments, the alkaline source material is Li₂O₂, Li₂O₂ with carbon nanotube, or Li₂O₂ with carbon nanotubes and an iron catalyst. In some embodiments, the alkaline source material is Li₂O₂, Li₂O lithiated sulfur, or mixture of any two or more. In some embodiments, the alkaline source material is Li₂O₂. In some embodiments, the alkaline source material is present in the carbon-coated alkaline source material from about 0.1 wt % to about 99 wt %.

In another aspect, a process for preparing laminated cathode includes combining a carbon-coated alkaline source material, and a binder in a solvent to form a slurry; applying the slurry to a surface of an electrode, wherein the electrode comprises a current collector having deposited thereon a cathode active material and a binder; and curing the slurry on the surface. In some embodiments, the curing includes removing the solvent from the slurry after applying. In some embodiments, the alkaline source material is Li₂O₂, Li₂O₂ with carbon nanotube, or Li₂O₂ with carbon nanotubes and an iron catalyst. In some embodiments, the alkaline source material is Li₂O₂, Li₂O lithiated sulfur, or mixture of any two or more. In some embodiments, the alkaline source material is Li₂O₂. In some embodiments, the alkaline source material is present in the carbon-coated alkaline source material from about 0.1 wt % to about 99 wt %.

In another aspect, a battery includes a laminated cathode having a current collector, a first layer comprising a cathode active material and a binder, and a second layer deposited on the first layer, the second layer comprising a carbon-coated alkaline source material; an anode; a separator disposed between the anode and the laminated cathode; and an electrolyte including a solvent and a salt. In some embodiments, the alkaline source material includes Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, or a mixture of any two or more thereof. In some embodiments, the anode includes a conductive carbon material, Li metal, Sb, Si, Si—C, SiO, Sn, tin oxide, Li₄Ti₅O₁₂, a composite tin alloy, a transition metal oxide, a lithium metal nitride, phosphorous, a phosphorous carbon composite, or a mixture of any two or more thereof. In some embodiments, the solvent is ethylene carbonate (EC), dimethyl carbonate (DMC), diethyl carbonate (DEC), propylene carbonate (PC), fluoroethylene carbonate (FEC), ethyl methyl carbonate (EMC), dioloxane, 7-butyrolactone, S-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a N-alkylpyrrolidone, fluoro ether and fluoro esters, fluoroethylene carbonate, adiponitrile, or a mixture of any two or more thereof. In some embodiments, the solvent is FEC-DEC, FEC-EC-DEC, FEC-EMC, FEC-EC-EMC, EC-DMC, EC-DEC, EC-PC, EC-PC-DMC, EC-PC-DEC, or EC-DEC-DMC. In some embodiments, the salt is a lithium salt, a sodium salt, an ammonium salt, an alkylammonium salt, a lithium polysulfide, or a lithium polyselenide. In some embodiments, the alkaline source material is Li₂O₂, Li₂O₂ with carbon nanotube, or Li₂O₂ with carbon nanotubes and an iron catalyst. In some embodiments, the alkaline source material is Li₂O₂, Li₂O, lithiated sulfur, or mixture of any two or more. In some embodiments, the alkaline source material is Li₂O₂. In some embodiments, the alkaline source material is present in the laminate cathode from about 0.1 wt % to about 99 wt %.

In another aspect, an electrolyte includes a polar aprotic solvent, a salt, and a carbon-coated alkaline source material suspended in the polar aprotic solvent. In some embodiments, the alkaline source material includes Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, or a mixture of any two or more thereof. In some embodiments, the alkaline source material is Li₂O₂, Li₂O₂ with carbon nanotube, or Li₂O₂ with carbon nanotubes and an iron catalyst. In some embodiments, the alkaline source material is Li₂O₂, Li₂O lithiated sulfur, or mixture of any two or more. In some embodiments, the alkaline source material is Li₂O₂. In some embodiments, the alkaline source material is present in the electrolyte from about 0.1 wt % to about 40 wt %.

### BRIEF DESCRIPTION OF THE DRAWINGS

FIG. 1 is a simplified cross-sectional view graph of a secondary battery construction including a cathode, coating layer, anode, separator and electrolyte.

FIG. 2 is the first charge curve of charge of the Li₂O₂ as cathode material vs. Li metal anode, according to Example 1.

FIG. 3 is the cycling performance of NMC∥Si full cells with and without Li₂O₂ in the cathode, according to Example 1.

FIG. 4 is a composite graph of the first de-lithiation curve of the lithiated sulfur as cathode material vs. Li metal, according to Example 2.

FIG. 5 is a composite graph of the first de-lithiation curve of the carbon-coated and confined lithiated sulfur as cathode material vs. Li metal, according to Example 2.

FIG. 6 is a composite graph of the first charge and discharge of the batteries containing carbon-coated lithiated sulfur in NMC cathode vs. Si anode, according to Example 2.

FIG. 7 is the cycling performance of NMC∥Si full cells with and without carbon-coated lithiated sulfur, according to Example 2.

FIG. 8 is a composite graph of the first charge curve of the coating layer containing Li₂O₂ on cathode vs. Li metal anode, according to Example 3.

FIG. 9 is a composite graph of the first charge curve of the coating layer containing Li₂O₂, conductive carbon C65, and carbon nanotube on cathode vs. Li metal anode, according to Example 3.

FIG. 10 is a composite graph of the first charge curve of the coating layer containing Li₂O₂, conductive carbon C65, iron catalyst, and carbon nanotube on cathode vs. Li metal anode, according to Example 3.

FIG. 11 is a composite graph of the first formation charge of cells and the recovered cyclable lithium-ion from silicon anode in NMC∥Si full cells with and without Li₂O₂, according to Example 3.

FIG. 12 is a composite graph of the cycling performance of cells with and without Li₂O₂NMC∥Si full cells, according to Example 3.

FIG. 13 is a composite graph of the first formation charge and the recovered cyclable lithium-ion from silicon anode in NMC∥Si full cells with and without Li₂O₂ (with carbon), according to Example 3.

FIG. 14 is a composite graph of the cycling performance of NMC∥Si full cells with and without Li₂O₂ (with carbon), according to Example 3.

FIG. 15 is a composite graph of the first formation charge and the recovered cyclable lithium-ion from silicon anode in NMC∥Si full cells with and without Li₂O₂ (with carbon and catalyst), according to Example 3.

FIG. 16 is a composite graph of the first formation charge and the recovered cyclable lithium-ion from silicon anode in NMC∥Si full cells applying electrolyte with and without Li₂O₂, according to Example 4.

FIG. 17 is a composite graph of the cycling performance of NMC∥Si full cells containing electrolyte with and without Li₂O₂, according to Example 4.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

To meet the power and energy requirements for all-electric vehicles, there is a need for high energy density chemistry offering more than 200 Wh per kg at the pack level, corresponding to 300 to 350 Wh per kg at the cell level. The state-of-the-art battery technology is not able to meet the energy density requirement set by the electric vehicle market. Pre-lithiation is a useful strategy to increase the energy density of batteries by mitigating the loss of activate lithium due to the formation of solid electrolyte interphase during the first cycle and during the subsequent cycling cycles.

Active alkaline source materials, such as Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, or a mixture of any two or more thereof may used to form a pre-activation material to supply lithium to the anode during the initial formation cycle, improving the first cycle efficiency of the cell. These materials are called pre-lithiating agents. However, the alkaline source materials self-activate, only with difficulty. Therefore, to improve the reaction kinetics of alkaline source materials, catalysts and carbon coatings have been found to improve the process. For example, carbon coating can reduce or prevent the dissolution or reaction of some alkaline source materials in the cathode slurry used to prepare an electrode by coating a current collector. It is also necessary to address issues raised by electrode swelling and de-lamination. Herein, we provide for a method of applying alkaline source materials as electrolyte additives.

The method includes introducing carbon coating of an alkaline source powder to improve its chemical stability, structural stability, and conductivity during activation to provide lithium ion needed to improve the columbic efficiency of the cell. In some methods, the alkaline source materials are mixed with carbon and a catalyst to form a composite material that can then be added to a cathode mixture or slurry for cathode preparation. The alkaline source materials may also be used as electrolyte additives in lithium ion battery to provide an additional lithium ion source to improve the efficiency of the cell and to limit inner volume change. The electrochemical performance of batteries employing alkaline source materials prepared as noted herein is significantly improved with regard to the first cycle efficiency of the cell, compared to other pre-lithiation methods. The methods described herein, have been shown to successfully lower the activation potential of alkaline source materials, achieve 100% activation of alkaline source materials, and avoid the compatibility issues when making cathode slurries.

In one aspect, a secondary battery is provided having a high specific capacity and good cyclability, and that can be used safely. The secondary battery includes a positive electrode (cathode), a negative electrode (anode), a coating layer on cathode, an electrolyte, and a separator. The cathode includes an alkali (Li or Na) source material configured to supply lithium or sodium to the battery. The secondary batteries include, but are not limited to, lithium-ion batteries, lithium-air batteries, lithium-sulfur batteries, sodium batteries, and other rechargeable batteries. In some embodiments, the battery is a lithium-air battery. In some embodiments, the battery is a lithium-sulfur battery. Also included are the cathodes for such secondary batteries, procedures for preparing such cathode and batteries, and methods of operating a secondary battery.

In some embodiments, the cathode also includes a cathode active material. The cathode laminate spread coating layer is also included for such secondary batteries, procedures for preparing such spread layer and batteries, and methods of operating a secondary battery including such a spread coating layer are included. The electrolyte is also included for such secondary batteries, procedures for preparing such electrolyte and batteries, and methods of operating a secondary battery containing such an electrolyte are included.

In some embodiments, the secondary batteries and cathodes described herein may be “as-prepared” secondary batteries and cathodes. As used herein, “as-prepared” refers to a cathode or battery, as prepared, prior to any charging of the battery or cathode, or discharging of the battery or cathode. The “as-prepared” does not imply any sort of time constraint, or in other words, the cathode or battery may actually have been prepared long ago, but it was not subjected to any charging or discharging process. Accordingly, the as-prepared cathode or battery has not been subjected to electrochemical processes that would generate any lithium or sodium species other those species that were included in the battery or cathode in the first instance. In some embodiments, the secondary battery is a non-discharged secondary battery. In other embodiments, the cathode is a non-discharged cathode.

The alkaline source materials are materials that may be put in or on the cathode in a cell to be activated and supply lithium or sodium ions to the anode to improve the first initial columbic efficiency of the secondary cell. Accordingly, an alkaline source material provides, at least a portion of, the transporter species in a battery: e.g. the lithium ions or the sodium ions. The alkaline source materials include lithium source materials, in some embodiments. In other embodiments, the alkaline source material is a sodium source material. The alkaline source material may include, but is not limited to Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, lithiated metal oxide or lithiated metal phosphate. Where the secondary battery is a lithium-ion battery, lithium sulfur or a lithium air battery, the alkaline source material may include, but is not limited to, Li₂O (lithia), Li₂O₂, LiO₂, Li₂S, Li₂Se, polysulfides, polyselenides, LiF, LiCl, LiBr, lithiated metal oxide or lithiated metal phosphate. Where the secondary battery is a sodium ion battery, or a sodium air battery, the alkaline source material may include, but is not limited to, Na₂O, Na₂O₂, NaO₂, Na₂S, Na₂Se, polysulfides, polyselenides, NaF, and NaCl, sodiated metal oxide or sodiated methosphate. In some embodiments, the alkaline source material is Li₂O₂. In some embodiments, the alkaline source material is lithiated sulfur either coated with carbon or incorporated inside carbon. It is noted that even where the battery is a sodium battery, alkaline source material containing lithium such as Li₂O₂ may be used to balance the cells.

In U.S. Pat. No. 9,012,091 (“the '291 Patent”), we described a procedure for activating the alkaline source material, namely Li₂O, in the battery cell. The Li₂O is used to compensate the first cycle irreversibility of a system using high-capacity composite cathode material such as Li₂MnO₃-LiMO₂ (M=Mn, Ni, Co). In this, and other materials, the activation of Li₂O may enable the use of a high energy density anode with high first-cycle irreversibility, such as silicon. However, a high activation potential is necessary to activate such alkaline source materials. As described in Example 1 of the '291 patent, when Li₂O is used alone in the electrode with binder and a carbon additive, the process of Li₂O activation occurs at a voltage above 4.5-4.7 V, and although not stated in the example, the charging is conducted at room temperature. In example Example 2 of the '291 Patent, the cell was charged at room temperature and 4.6 V.

In U.S. Patent Publication No. 2017/0207500 (“the '500 Publication”), it is noted that by conducting the initial charging at elevated temperatures lower voltages may be used to achieve the activation without sacrificing the reversibility of the capacity. The reduction of the potential applied during activation of the alkaline source material, may allow for the use of alkaline source material as a source of alkali-ion batteries. In Example 2 of the '500 Publication, Li₂O is used to compensate for the first cycle irreversibility of a lithium-ion battery, or as a lithium source for a lithium air system, with anodes such as silicon and tin based materials. In addition, this activation is noted to occur below the starting of the electrolyte decomposition voltage, i.e. approximately 4.2 V. At elevated temperatures (in some embodiments from 40° C. to 80° C., or from 50° C. to 60° C., or in some embodiments at about 55° C.) Li₂O activation may occur during the first charge, or for a shorter period of time.

However, in neither the '291 Patent, or the '500 Publication, there is not discussion that the activation potential of the alkaline source materials can be further lowered by being coated with, or incorporated into, carbon materials. Methods of applying alkaline source materials to avoid compatibility issues are also not described in either document. Therefore, carbon-coated, or confined, alkaline source materials are described herein, as are methods of preparing a conducting layer on the cathode together with conductive carbon and a catalyst and the mixing of alkaline source materials in electrolytes. The methods described herein enable the sacrificial activation of alkaline source materials at low voltage and low temperature, and avoid compatibility issues during the lamination process of preparing cathodes.

The present methods introduce carbon coating of alkaline material and catalyst mixed with either alkaline or carbon-coated alkaline material to improve the chemical and structural stability, and lower the activation potential of alkaline source materials. The method of applying alkaline source-carbon-catalyst composite material as an electron and ion conducting layer on top of cathode which can be incorporated into a real cell to avoid the compatibility issues and further lower the activation potential of alkaline source. The methods also describe adding alkaline source materials into electrolytes as additives for batteries to enable the utilization of alkaline source materials. The electrochemical performance of batteries employing alkaline source materials with at least one of the above methods have been improved significantly.

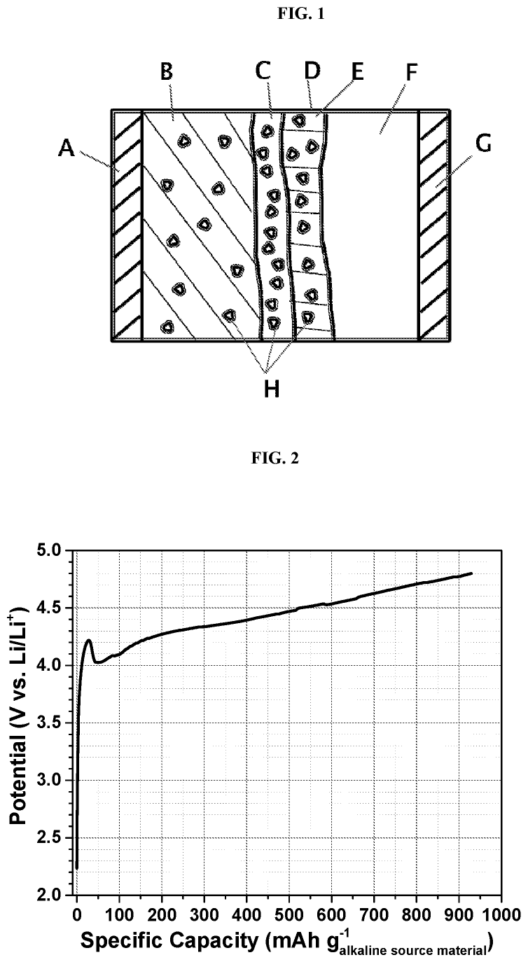

FIG. 1 is an illustration of a battery cell. The cell includes components such as, but not limited to: a cathode current collector (A) for a cathode (B), a coating layer (C) on the cathode (B), a separator (D), an electrolyte (E), an anode (F), and an anode current collector (G). Alkaline source materials (H) may be located in or on any of the cathode, the coating layer, or the separator, or in the electrolyte. The cathodes are typically formed by coating a slurry of cathode active material, solvent, and binders onto a current collector, and then removing the solvent. To avoid potential compatibility issues with introducing some alkaline source materials into the cathode slurry, it has been found that the alkaline source material may be dispersed on the cathode as a coating layer. The method forming the cathode coating layer may include but not limit to spread, spraying, blending, coating, vapor phase deposition, spraying, firing, and liquid-phase deposition, chemical vapor deposition (CVD), electrochemical deposition, atomic layer deposition (ALD), molten methods utilizing an arc melting furnace, a high frequency induction heater, mechanical alloying, gas atomizing, or other mechanical or chemical means. The coating layer may include a catalyst and carbon, where the layer is configured to activate the alkaline source material at low voltage to release lithium or sodium ions.

Carbon-coating is an important method enabling the utilization of alkaline source materials. For the methods, a non-lithiated precursor of an alkaline source material, for example sulfur or carbon disulfide, can be lithiated with a lithium-containing reagent such as lithium gas. The non-lithiated precursor may be mixed with, or coated with, a carbon source such as, but not limited to, carbon nanotubes, carbon fiber, microporous carbon, mesoporous carbon, macroporous carbon, mesoporous microbeads, graphene, reduced graphene oxide, graphite, expandable graphite, polymer yield carbon (such as polyacrylonitrile), Super P, Black Pearl 2000, Denka Black, Vulcan XC72R, Ketjen black, or combination of any two or more thereof. As one example, where the alkaline source material is Li₂S, one way of incorporating Li₂S in a carbon matrix is to flow CS₂ gas in a reactor that contains Li metal. The CS₂ gas will react with lithium metal at temperature higher than 180° C. to form Li₂S caged in graphene sheets. Another way of incorporating Li₂S into the carbon matrix is by reducing sulfur inside mesoporous carbon-sulfur composites, which are formed by melting the sulfur in a carbon-sulfur mixture, with lithium containing reducing agent such as, but not limited to, lithium, lithium polysulfides, lithium hydride, lithium borohydride, lithium aluminumhydride, alkyl lithium, or aryl lithium reducing agents.

The method of carbon coating may include high-energy mixing, vapor phase deposition, plasma-assisted chemical vapor deposition (CVD), spraying, liquid-phase deposition, electrochemical deposition, plasma enhanced atomic layer deposition, calcination of carbon precursor, or other mechanical or chemical means.

CVD may used to facilitate coating of the alkaline source material with carbon. In such a method, an alkaline source material is loaded in a rotating quartz tube reactor. After purging with argon, the reactor is heated, and when at the desired temperature, a mixture of acetylene (C₂H₂) and argon gas is introduced to the reactor. During cooling to room temperature, the acetylene flow is terminated and the argon flow is maintained. The carbon-coated alkaline source material is then collected. Hydrocarbon gases other than acetylene, such as, but not limited to, toluene (C₇H₈), ethylene, or propylene (C₃H₆) may be used.

A carbon shell may be synthesized to confine the alkaline source materials inside, via a carbothermic reduction. For example, 100 mg Li₂O₂ is loaded in a quartz tube reactor. After purging with Ar (100 sccm) for 60 min, the reactor is heated with ramp rate 10° C. min⁻¹ to 150 to 450° C. After reaching the temperature, acetylene (C₂H₂) and argon gas mixture is introduced with flow rate C₂H₂/Ar=10/20 sccm for 30 min., the acetylene is cut off and argon is kept filling into the reactor. The temperature can be later further increased to 400 to 1000° C. to fully carbonize all carbon source. Finally, during cooling down to room temperature, argon is kept filling into the reactor and carbon-coated Li₂O₂ composite is collected. The acetylene may be substituted with toluene (C₇H₈), or propylene (C₃H₆) or other hydrocarbon gas sources. The simplified reactions are shown below.

2Li₂O₂→2Li₂O+O₂↑

C₂H₂→C+RH

To synthesize a catalyst embedded alkaline material, typically, 100 mg Li₂O₂ and 0.1 to 100 mg of catalyst composite is loaded in a quartz tube reactor. After purging with Ar (100 sccm) for 60 min, the reactor is heated with ramp rate 10° C. min⁻¹ to 150 to 450° C. After reaching the temperature, acetylene (C₂H₂) and argon gas mixture is introduced with flow rate C₂H₂/Ar=10/20 sccm for 30 min, the acetylene is cut off and argon is kept filling into the reactor. The temperature may be later further increased to 400 to 1000° C. to fully carbonize all carbon source. Finally, during cooling down to room temperature, argon is kept filling into the reactor and carbon-coated Li₂O composite is collected. The acetylene may be substituted with toluene (C₇Hs), or propylene (C₃H₆) or other hydrocarbon gas sources.

Carbon coating on the alkaline source materials can also be performed through the calcination of a carbon precursor. The process includes mixing of the alkaline source materials with a non-aqueous or aqueous solution of a saccharide or a saccharide derivative, a polyol, or other thermoplastic polymers or petroleum pitch; drying of the mixture to obtain solid particles; and calcining the solid particles at a temperature from 300° C. to 1500° C. The calcination may be conducted under inert atmosphere or in air, according to different embodiments. Where a saccharide or saccharide derivative is to be used, it may be one or more of glucose, fructose, sucrose, maltose, amylose, ribose, glyceraldehyde, dihydroxyacetone, arabinose, seduheptulose, mannoheptulose, allose, altrose, mannose, gulose, idose, talose, amylopectin, uronic acid, glycogen, lactose, xylose, galactose, starch, cellulose, cellulose acetate, cellulose acetate butyrate, chitin, callose, chitosan, laminarin, chrysolaminarin, xylan, arabinoxylan, mannan, fucoidan, or galactomannan. Where a polyol is to be used, it may be one or more of xylitol, pentartythritol, isomalt, lactitol, ethylene glycol, propylene glycol, threitol, arabitol, ribitol, galactitol, fucitol, iditol, inositol, volemitol, sorbitol, mannitol, erythritol, glycerol, maltitol, polyether polyol, polyester polyol, or polyvinyl alcohol. Where a thermoplastic polymer is to be used, it may be one or more of a polyester, polyamide, polybutadiene, polyethylene, polypropylene, polyactic acid, polyacrylic acid, styrene-butadiene rubber, poly(methyl methacrylate), polyacrylonitrile, polybenzimidazole, polycarbonate, polyether sulfone, polyoxymethylene, polyether ether ketone, or polyetherimide. A solvent may be used to dissolve the carbon precursors. Suitable solvents include, but are not limited to, water, methanol, ethanol, propanol, isopropanol, n-butanol, s-butanol, t-butanol, acetone, acetophenone, ethyl isopropyl ketone, mesityl oxide, butanone, cyclopentanone, cyclohexanone, hexanone, isophorone, methyl isobutyl ketone, methyl isopropyl ketone, 3-methyl-2-pentanone, pentanone, dichloromethane, chloroform, vinyl chloride, dichloroethene, tetrachloroethene, trichloroethane, trichloroethene, tetrachloromethane, trichloroethylene, pentane, hexane, heptane, cyclohexane, cyclopentane, cycloheptane, cyclopentene, cyclohexene, hexene, heptene, benzene, toluene, xylene, mesitylene, diethyl ether, methyl t-butyl ether, tetrahydrofuran, dimethoxyethane, diglyme, ethylene glycol, propylene glycol, ethylene glycol monoether, diglyme, triglyme, tetraglyme, dioxane, dimethyl sulfoxide, acetonitrile, propanenitrile, dimethylformamide, dimethylacetamide, N-methyl-2-pyrrolidone, trimethylphosphate, triethylphosphate, trimethylphosphite, triethylphosphite, methyl acetate, ethyl acetate, dimethyl carbonate, ethyl methyl carbonate, diethyl carbonate, propylene carbonate, butyrolactone, or a mixture of any two or more thereof.

A carbon composite with an alkaline source materials can also be obtained by high-energy milling of the alkaline source materials with carbon. The process includes placing the alkaline source materials and carbon in a stainless-steel container and applying high energy ball milling under air or inert atmosphere. The speed of milling can be fixed, or it may be variable. Solvents, as noted above, may also be added to facilitate the mixing process. The composite obtained by the high-energy illing may be dried at elevated temperatures, vacuum dried, or freeze-dried to remove the solvent.

A method of coating Li₂O₂ or other alkaline source materials on top of cathode laminate leads to a significant activation of Li₂O₂, which avoid compatibility issues of making slurry and provide a high capacity depending on the amount of Li₂O₂. Li₂O₂ with conductive carbon and catalyst may be put on the cathode laminate after the preparation of cathode laminate, according to Example 3. Conductive carbon and catalyst(s) may be added into the spread coating layer to facilitate the activation of alkaline source materials. Conductive carbons include, but are not limited to, carbon nanotubes, carbon fiber, microporous carbon, mesoporous carbon, macroporous carbon, mesoporous microbeads, graphite, expandable graphite, polymer yield carbon (such as polyacrylonitrile), or carbon black. Commercial examples of carbon black include, but are not limited to, Super P, Black Pearl 2000, Denka Black, Vulcan XC72R, Ketjen black may be mixed together. Catalyst including nanostructured carbon functionalized, polymers, transition metal oxides, non-precious metals, precious metals or metal alloys may also mix together. A solvent or co-solvent, such as toluene and hexane may need to help disperse the alkaline source materials. Such solvents also include ethylene carbonate (EC), dimethyl carbonate (DMC), diethyl carbonate (DEC), propylene carbonate (PC), fluoroethylene carbonate (FEC), ethyl methyl carbonate (EMC), dioloxane, 7-butyrolactone, S-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, an oligo ether, a phosphate ester, a siloxane, a N-alkylpyrrolidone, fluoro ether and fluoro esters, fluoroethylene carbonate, or adiponitrile. Of course, a mixture of any two or more such solvents may also be used. In some embodiments, the solvent is a mixture of solvents such as, but not limited to, FEC-DEC, FEC-EC-DEC, FEC-EMC, FEC-EC-EMC, EC-DMC, EC-DEC, EC-PC, EC-PC-DMC, EC-PC-DEC, or EC-DEC-DMC.

The as mentioned methods of preparing carbon coating of alkaline source materials and electrode coating layer containing alkaline source materials also apply to Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr or a mixture of any two or more.

The alkaline source materials may be finely divided into particles having a mean size of less than 50 m. For example, the particles may have a mean particle size of from about 0.1 nm to about 50 m. In some embodiments, the particles may have a mean particle size of from about 0.1 nm to about 1000 nm. In yet other embodiments, the particles may have a mean particle size of less than 1 nm, in yet other embodiments, the particles may have a mean particle size of from about 20 nm to about 500 nm. In yet other embodiments, the particles may have a mean particle size of from about 20 nm to about 100 nm. In yet other embodiments, the particles may have a mean particle size of from about 100 nm to about 10 m.

For example, in some embodiments, the Li₂O₂ is particulate. The Li₂O₂ may have a mean particle size of less than 10 m, or any of the size ranges listed in the previous paragraph. In some embodiments, the Li₂S is particulate. The Li₂S may have a mean particle size of less than 10 nm, or any of the size ranges listed in the previous paragraph.

Putting the alkaline source material, e.g., Li₂O₂, in the electrolyte may lead to an activation of Li₂O₂ which provide a high capacity based on the weight of Li₂O₂. Li₂O₂ may be put in the electrolyte during or after the preparation of electrolyte. Where the electrolyte contains an alkaline source material, the alkaline source material may be present from about 0.1 wt % to about 30 wt % of the electrolyte. In some embodiments, the alkaline source material is present from about 0.1 wt % to about 20 wt %. In further embodiments, the alkaline source material is present from about 0.5 wt % to about 5 wt %. In one embodiment, the electrolyte may include a solvent and a salt. Suitable solvents for use in the electrolytes are typically polar aprotic solvents. Illustrative solvents include, but are not limited to, ethylene carbonate (EC), dimethyl carbonate (DMC), diethyl carbonate (DEC), propylene carbonate (PC), fluoroethylene carbonate (FEC), ethyl methyl carbonate (EMC), dioloxane, 7-butyrolactone, S-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a N-alkylpyrrolidone, fluoro ether and fluoro esters, fluoroethylene carbonate, or adiponitrile. Of course, a mixture of any two or more such solvents may also be used. In some embodiments, the solvent is a mixture of solvents such as, but not limited to, FEC-DEC, FEC-EC-DEC, FEC-EMC, FEC-EC-EMC, EC-DMC, EC-DEC, EC-PC, EC-PC-DMC, EC-PC-DEC, or EC-DEC-DMC. In some embodiments, fluorinated derivatives of the above solvents may be used. Suitable salt materials include, but are not limited to, a lithium salt, a sodium salt, an ammonium salt, an alkylammonium salt, a lithium polysulfide, or a lithium polyselenide. Illustrative salts are LiPF₆, LiClO₄, (C₄BO₈Li), (C₂BO₄F₂Li), LiPF₄C₂O₄, Li(CF₃SO₂)₂N, LiC(SO₂CF₃)₃, (Li(C₂F₅SO₂)₂N), LiCF₃SO₃, Li₂B₁₂X₁₂₋ₙHₙ, Li₂B₁₀X_{10-n″}H_{n″} where X is a halogen, n is an integer from 0 to 12, and n′ is an integer from 0 to 10, LiAlF₄, LiBF₄, Li(FSO₂)₂N, Li₂SO₄, Na₂SO₄, NaPF₆, NaClO₄, LiAlO₂ LiSCN, LiBr, LiI, LiAsF₆, LiB(Ph)₄, LiSO₃CH₃, Li₂S_{x″}Li₂Seₓ″, (LiS_{x″}R)_{y} or (LiSe_{x″}R)_{y}; wherein x″ is an integer from 1 to 20, y is an integer from 1 to 3 and R is H, alkyl, alkenyl, aryl, ether, F, CF₃, COCF₃, SO₂CF₃, or SO₂F. The as mentioned electrolyte additive method also applies to Na₂O, Na₂O₂, NaO₂, Na₂S, Na₂Se, NaF, NaCl, NaBr, Li₂O, Li₂O₂, LiO₂, lithiated sulfur (including Li₂S), polysulfide, Li₂Se, polyselenide, LiF, LiCl, LiBr or a mixture of any two or more.

Where the battery is a lithium air battery, the cathode may include a porous carbon material, a catalyst, and the alkaline source material. For example, where the battery is a lithium air battery, the cathode may include a porous carbon material, a catalyst, Li₂O, Li₂O₂, or LiO₂. In other lithium-ion batteries, where the cathode includes non-lithiated active materials, e.g., MnO₂, the amount of alkaline source material in the cathode may be from about 1 wt % to about 40 wt % in the as-prepared cathode. This includes where the amount of alkaline source material in the cathode is from about 5 wt % to about 10 wt %, or from about 10 wt % to about 40 wt % in the as-prepared cathode. Where the cathode includes lithiated active materials, e.g., LiFePO₄, the amount of alkaline source material in the cathode is from about 1 wt % to about 10 wt % in the as-prepared cathode.

Where the battery is a sodium air battery, the cathode may include a porous carbon material, a catalyst, and Na₂O Na₂O₂, or NaO₂. In other sodium ion batteries, where the cathode includes non-sodiated active materials, e.g. MnO₂, the amount of alkaline source material in the cathode may be from about 1 wt % to about 40 wt % in the as-prepared cathode. This includes where the amount of alkaline source material in the cathode is from about 5 wt % to about 10 wt %, or from about 10 wt % to about 40 wt % in the as-prepared cathode.

Where the battery is a sodium ion battery, the cathode may include a porous carbon material, a catalyst, and the alkaline source material. The amount of alkaline source material in the cathode may be from about 1 wt % to about 40 wt %. This includes where the amount of alkaline source material in the cathode is from about 5 wt % to about 10 wt %, or from about 10 wt % to about 40 wt % of the cathode.

For lithium secondary batteries, or cathodes to be used in lithium secondary batteries, the cathodic material may include either lithiated materials or surface coated lithiated materials. For example, such materials and composites include, but are not limited to, MnO₂, V₂O₅, LiVO₃, air (oxygen), FeF₂, a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, Li₁₊ₓMn_{2-z}M⁴_{y}O₄₋ₘX¹ₙ, LiFe_{1-z}M⁶_{y}PO₄₋ₘX¹ₙ, LiMn_{1/3}Co_{1/3}Ni_{1/3}O₂, LiM n₂O₄, LiFeO₂, LiM⁴_{0.5}Mn_{1.5}O₄, Li₁₊ₓNi_{α}Mn_{β}Co_{γ}M⁵_{δ}O_{2-z″} both single composition or gradient composition, Li₂MnO₃-LiₐM_{b}M′_{c}M″_{d}Oₑ, Liₙ—B¹₂(M²O₄)₃ (Nasicon), Li₂MSiO₄, or a mixture of any two or more thereof, wherein M² is P, S, Si, W, or Mo; M⁴ is Al, Mg, Ti, B, Ga, Si, Ni, or Co; M⁵ is Mg, Zn, Al, Ga, B, Zr, or Ti; A is Li, Ag, Cu, Na, Mn, Fe, Co, Ni, or Zn; M⁶ is Al, Mg, Ti, B, Ga, Si, Ni, Mn or Co; M, M′, and M″ are transition metals; B¹ is Ti, V, Cr, Fe, or Zr; X¹ is S or F; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤α≤1; 0≤β≤1; 0≤γ≤1; 0≤δ≤0.4; 0≤z″≤0.4; 0≤n′≤3; 0≤a+b+c+d≤6; 0≤e≤4; and 0≤α+β+γ+δ.

For sodium secondary batteries, or cathodes to be used in sodiated secondary batteries, the cathodic material may include either sodiated materials or surface coated sodiated materials. For example, such materials and composites include, but are not limited to a spinel, an olivine, a carbon-coated olivine, NaFePO₄, NaCoO₂, NaNiO₂, NaNi₁₋ₓCo_{y}M⁴_{z}O₂, NaMn_{0.5}Ni_{0.5}O₂, NaMn_{1/3}Co_{1/3}Ni_{1/3}O₂, NaMn₂O₄, NaFeO₂, NaM⁴_{0.5}Mn_{1.5}O₄, Na₁₊ₓ-Ni_{α}Mn_{β}Co_{γ}M⁵_{δ}O_{2-z″}F_{z″}, Na₂MnO₃-NaₐM_{b}M′_{c}M″_{d}Oₑ, Naₙ—B¹₂(M²O₄)₃ (Nasicon), Na₂MSiO₄, NaVPO₄F or a mixture of any two or more thereof, wherein M² is P, S, Si, W, or Mo; M⁴ is Al, Mg, Ti, B, Ga, Si, Mn, or Co; M⁵ is Mg, Zn, Al, Ga, B, Zr, or Ti; M, M′, and M″ are transition metals; B¹ is Ti, V, Cr, Fe, or Zr; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤δ≤1; 0≤β≤1; 0≤γ≤1; 0≤δ≤1; 0≤δ′≤0.4; 0≤z″≤0.4; 0≤n′≤3; 0≤a+b+c+d, and 0<e.

The cathodic material may include, in some embodiments, a spinel, an olivine, or a carbon-coated olivine. For example, the cathodic material may be, according to an embodiment, a spinel manganese oxide of formula of Li₁₊ₓMn_{2-z}M⁴_{y}O₄₋ₘX¹ₙ, wherein M⁴ is Al, Mg, Ti, B, Ga, Si, Ni, or Co; X¹ is S or F; 0≤x≤0.3; 0≤y≤0.5; 0≤z≤0.5; 0≤m≤0.5; and 0≤n≤0.5. The cathodic material may be, according to an embodiment, an olivine of formula of LiFe_{1-z}M⁶_{y}PO₄₋ₘX¹ₙ or a mixture of any two or more such olivines; wherein M⁶ is Al, Mg, Ti, B, Ga, Si, Ni, Mn or Co; X¹ is S or F; 0≤x≤0.3; 0≤y≤0.5; 0≤z≤0.5; 0≤m≤0.5; and 0≤n≤0.5.

The cathodic material may include a blend of a spinel and Li₁₊ₓ-Ni_{α}Mn_{β}Co_{γ}M⁵_{δ}O_{2-z″}F_{z}, wherein M⁵ is Mg, Zn, Al, Ga, B, Zr, or Ti; 0≤x″≤0.4; 0≤α≤1; 0≤β≤1; 0≤y≤1; 0≤δ≤0.4; 0≤z″≤0.4; 0≤α+β+γ+δ. The ratio of the spinel to the Li₁₊ₓ-Ni_{α}Mn_{β}Co_{γ}M⁵_{δ}O_{2-z″}F_{z″} may be from about 0.5 wt % to about 98 wt %. Alternatively, the cathode may include a blend of an olivine or a carbon-coated olivine, and Li₁₊ₓ-Ni_{α}Mn_{β}Co_{γ}M⁵_{δ}O_{2-z″}F_{z″} wherein M⁵ is Mg, Zn, Al, Ga, B, Zr, or Ti; 0≤x″≤0.4; 0≤α≤1; 0≤β≤1; 0≤γ≤1; 0≤δ≤0.4; 0≤z″≤0.4; 0≤α+β+γ+δ. The ratio of the ratio of the olivine or carbon-coated olivine to the Li₁₊ₓ-Ni_{α}Mn_{β}Co_{γ}M⁵_{δ}O_{2-z″}F_{z″} may be from about 0.5 wt % to about 98 wt %.

The cathodic material may include a non-lithiated or non-sodiated material such as MnO₂, V₂O₅, LiVO₃, MoS₂, FeS₂, S, organic cathode, air or oxygen cathode such as carbon, FeF₃, FeF₂, or a mixture of any two or more thereof. In other embodiments, the cathodic material includes sulfur. In some embodiments, the cathodic material is air (oxygen).

Where the cathode is for use in a sodium ion electrochemical cell, the cathodic material may include NaM₁₋ₓM′ₓPO₄, NaₓM_{y}M′_{z}O₂, Na₂FePO₄F, Na₂MnPO₄F, NaFeSO₄F, NaMnSO₄F, NaV_{1-α}Cr_{α}PO₄F, Na₂S, Na₂Se, or a mixture of any two or more thereof, wherein 0<x; 0<y+z; M is Mn, Ni, Fe, Co, or Cu; M′ is Cr or Mg; and 0≤α≤1.

The cathode may be further stabilized by surface coating the active particles with a material that can neutralize acid or otherwise lessen or prevent leaching of the transition metal ions. Hence the cathodes can also comprise a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, LiMPO₄ or LiMBO₃, where in M indicates transition metal such as but not limited to Ni, Mn, Co, or a mixture of any two or more thereof, or of any other suitable metal oxide or fluoride. The coating can be applied to a carbon-coated cathode. The cathode may be further stabilized by surface coating the active particles with polymer materials. Examples of polymer coating materials include, but not limited to, polysiloxanes, polyethylene glycol, or poly(3,4-ethylenedioxythio-phene) polystyrene sulfonate, a mixture of any two or more polymers. The cathode may be carbon-coated to improve the stability and conductivity via chemical or physical method. Examples of carbon coating includes but not limit to high-energy mixing, vapor phase deposition, plasma-assisted chemical vapor deposition (CVD), spraying, liquid-phase deposition, electrochemical deposition, plasma enhanced atomic layer deposition, calcination of carbon precursor, or other mechanical or chemical means.

The cathodes, or the cathode(s) of the secondary battery, also include a primary cathodic material. In some embodiments, the cathode includes a mixture of the alkaline source material and the primary cathodic material. The primary cathodic material may include a lithiated positive active material, a non-lithiated positive active material, a sodiated positive active material, a non-sodiated positive active material, or a mixture of any two or more thereof. In some embodiments, the primary cathodic material may include a lithiated positive active material, a sodiated positive active material, or a mixture of lithiated and sodiated positive active material.

The primary cathodic material may include a positive active material that is configured to only insert, or de-insert lithium or sodium. For example, the positive active material may be configured to only insert, or de-insert lithium from about 1.5 V to about 5.0 V vs. lithium. Alternatively, the positive active material may be configured to only insert, or de-insert sodium from 1.2 to 5.0 V vs. sodium. As used herein, “insert” or “de-insert” is used to refer to the movement of either the lithium or sodium ion(s) into, or out of, respectively, the cathode material either through absorption, adsorption, intercalation, conversion, or alloying.

In addition to the alkali source material and cathodic material, the cathode may include a current collector, a porous carbon (e.g. conductive) material, and/or a polymeric binder. The current collector may include copper, stainless steel, titanium, tantalum, platinum, gold, aluminum, nickel, cobalt-nickel alloys, highly alloyed ferritic stainless steel containing molybdenum and chromium; or nickel-, chromium-, or molybdenum-containing alloys. The current collector may be a foil, mesh, or screen, and the porous carbon material and optional metal oxide are contacted with the current collector by casting, pressing, or rolling the mixture thereto. The porous carbon material may include microporous carbon, mesoporous carbon, mesoporous microbeads, graphite, expandable graphite, carbon black, or carbon nanotubes. Commercial examples of carbon black include, but are not limited to, Super P, Black Pearl 2000, Denka Black, Vulcan XC72R, Ketjen black. The polymeric binder may include poly(acrylonitrile), poly(vinylidene fluoride), polyvinyl alcohol, polyethylene, polystyrene, polyethylene oxide, polytetrafluoroethylene, polyimide, styrene butadiene rubber, carboxy methyl cellulose, gelatin, or a copolymer of any two or more such polymers.

The anode in the secondary batteries described above may include graphite, Li metal, Sb, Si, Si—C, SiO, Sn, tin oxide, Li₄Ti₅O₁₂, a composite tin alloy, a transition metal oxide, hard carbon soft carbon or a lithium metal nitride, phosphorous including black and red phosphorous, and phosphorous carbon composite; as well as doped phosphorus carbon with Sb, Si, Si—C, SiO, Sn, tin oxide, Li₄Ti₅O₁₂, a composite tin alloy, a transition metal oxide, or a lithium metal nitride or a mixture of any two or more. While the battery includes Li₂O, Li₂O₂, lithiated sulfur (including Li₂S). The Li₂O₂, Li₂O, and lithiated sulfur (including Li₂S), may be activated during the initial charges and supply lithium source for batteries. The Li₂O₂, Li₂O, and lithiated sulfur (including Li₂S) may supply lithium for the anode, and after discharge, the lithium is transmitted from anode to cathode, then supply for the cathode material during battery cycling. The Li₂O₂, Li₂O, and lithiated sulfur (including Li₂S) may compensate for the anode initial irreversible capacity loss and supply lithium to the cathode material, in case a non-lithiated cathode material is used.

In addition to the Li-ion storage active material, the anode may also include a current collector, a conductive carbon material, a binder, or any combination thereof. The anode current collector may be prepared from a wide variety of materials. For example, illustrative current collectors include, but are not limited to, carbon, copper, stainless steel, titanium, tantalum, platinum, palladium, gold, silver, iron, aluminum, nickel, rhodium, manganese, vanadium, titanium, tungsten, cobalt nickel alloy, highly alloyed ferritic stainless steel containing molybdenum and chromium; or nickel-, chromium-, or molybdenum-containing alloys, or a carbon-coated metal described above. The current collector may take the form of a foil, mesh, or screen. In some embodiments, the electroactive material disclosed herein and one or more of a conductive carbon material and a binder are contacted with the current collector by casting, pressing, or rolling the mixture thereto. In some embodiments, the current collector is copper, stainless steel, titanium, tantalum, platinum, gold, aluminum, nickel, cobalt, cobalt nickel alloy, highly alloyed ferritic stainless steel containing molybdenum and chromium, a nickel-containing alloy, a chromium-containing alloy, or a molybdenum-containing alloy.

The current collectors may be in electrical contact with one another through an external circuit. The secondary battery may exhibit a jelly roll or stacked construction. A lithium source material (i.e., Li₂O₂) is incorporated on the positive electrode side or into the electrolyte.

When used, the binder may be present in the anodes in an amount of from about 0.1 wt % to about 99 wt %. In some embodiments, the binder is present in the electrode in an amount of from about 5 wt % to about 20 wt %. Illustrative binders include, but are not limited to, polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), poly(9,9-dioctylfluorene-co-fluorenone-co-methylbenzoic ester), a copolymer of any two or more such polymers, and a blend of any two or more such polymers. In some embodiments, the binder is an electrically conductive polymer such as, but not limited to, polythiophene, polyacetylene, poly(9,9-dioctylfluorene-co-fluorenone), poly(9,9-dioctylfluorene-co-fluorenone-co-methylbenzoic ester), and a copolymer of any two or more such conductive polymers.

When used, the binder may be present in the cathode in an amount of from about 0.1 wt % to about 99 wt %. In some embodiments, the binder is present in the electrode in an amount of from about 5 wt % to about 20 wt %. Illustrative binders include, but are not limited to, polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), poly(9,9-dioctylfluorene-co-fluorenone-co-methylbenzoic ester), a copolymer of any two or more such polymers, and a blend of any two or more such polymers. In some embodiments, the binder is an electrically conductive polymer such as, but not limited to, polythiophene, polyacetylene, poly(9,9-dioctylfluorene-co-fluorenone), poly(9,9-dioctylfluorene-co-fluorenone-co-methylbenzoic ester), and a copolymer of any two or more such conductive polymers.

In addition to a cathode and anode, the batteries may include a separator. Illustrative separators include, but are not limited to, polyethylene, polypropylene, or polyvinylidene fluoride.

In addition to a cathode and anode, the batteries may include an electrolyte. The electrolyte may include a solvent and a salt. Suitable solvents for use in the electrolytes are typically polar aprotic solvents. Illustrative solvents include, but are not limited to, ethylene carbonate, dimethylcarbonate, diethylcarbonate, propylene carbonate, fluoroethylene carbonate (FEC), ethyl methyl carbonate, dioloxane, γ-butyrolactone, δ-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a n-alkylpyrrolidone, fluoro ether and fluoro esters, fluoroethylene carbonate, or adiponitrile. Of course, a mixture of any two or more such solvents may also be used. In some embodiments, the solvent is a mixture of solvents such as, but not limited to, FEC-DEC, FEC-EC-DEC, FEC-EMC, FEC-EC-EMC, EC-DMC, EC-DEC, EC-PC, EC-PC-DMC, EC-PC-DEC, or EC-DEC-DMC. In some embodiments, fluorinated derivatives of the above solvents may be used. Suitable salt materials include, but are not limited to, a lithium salt, a sodium salt, an ammonium salt, an alkylammonium salt, a lithium polysulfide, or a lithium polyselenide. Illustrative salts are LiPF₆, LiClO₄, (C₄BO₈Li), (C₂BO₄F₂Li), LiPF₄C₂O₄, Li(CF₃SO₂)₂N, LiC(SO₂CF₃)₃, (Li(C₂F₅SO₂)₂N), LiCF₃SO₃, Li₂B₁₂X₁₂₋ₙHₙ, Li₂B₁₀X_{10-n″}H_{n″} where X is a halogen, n is an integer from 0 to 12, and n′ is an integer from 0 to 10, LiAlF₄, LiBF₄, Li(FSO₂)₂N, Li₂SO₄, Na₂SO₄, NaPF₆, NaClO₄, LiAlO₂ LiSCN, LiBr, LiI, LiAsF₆, LiB(Ph)₄, LiSO₃CH₃, Li₂Se_{x″}Li₂Se_{x″}, (LiSe_{x″}R)_{y} or (LiSe_{x″}R)_{y}; wherein x″ is an integer from 1 to 20, y is an integer from 1 to 3 and R is H, alkyl, alkenyl, aryl, ether, F, CF₃, COCF₃, SO₂CF₃, or SO₂F.

In another aspect, a method of operating a secondary battery is provided. In the method, an as-prepared secondary battery is provided, the secondary battery having a cathode, an alkaline coating layer on cathode, an anode, a separator, and electrolyte. The battery may include a coating layer of an alkali source material such as carbon-coated Li₂O and carbon-coated lithiated sulfur. The alkaline coating layer is manufactured with carbon-coated Li₂O or Li₂O₂ blending with a conductive carbon (e.g., C65) material then paste on top of the positive electrode. The electrolyte is the commonly used electrolyte but may contain alkaline source materials inside. The freshly assembled battery is in a discharged state. For example, the freshly assembled battery may be fully discharged, with all the alkaline source material, i.e. lithium or sodium, in the coating layer in the as-prepared battery. The method may include charging the as-prepared secondary battery by transmitting lithium (or sodium) ions from positive electrode to the negative electrode through the electrolyte. The secondary battery may then be discharged by transmitting lithium ions from the anode to cathode through the electrolyte, and then charging again by transmitting lithium (or sodium) ions from cathode to anode through the electrolyte

the batteries and electrochemical cells described herein may be used for various types of applications. For example, the secondary batteries may be used in portable electronics such as cell phones, laptop computers, and cameras, and in large power applications such in electric vehicles, hybrid electric vehicles, plug-in hybrid electric vehicles, and smart grids.

The present invention, thus generally described, will be understood more readily by reference to the following examples, which are provided by way of illustration and are not intended to be limiting of the present invention.

### EXAMPLES

Example 1. Alkaline Source Materials as a Cathode Material. The Alkaline source material, Li₂O₂, was used as the only cathode active material. Li₂O₂ was mixed with conductive carbon (“C45”) and binder (PVDF) in a mass ratio of 20:50:30 to form a cathode slurry. The cathode slurry was cast on an aluminum current collector followed by drying at 70° C. and 100° C. vacuum drying for 24 hours in total. The obtained cathode laminate was then calendared and cut for assembly into cells. A representative charge curve of Li₂O₂ as cathode vs. Li is shown in FIG. 2. The loading of Li₂O₂ was 0.8 mg. The electrolyte was 1.2 M LiPF₆ in a mixture of EC/EMC (3:7 by mass) with 10 wt. % FEC. The testing current is C/30 and cells are charged to 4.8V. The example demonstrates that when tested at 22° C., Li₂O₂ can be activated, but no stable plateau is observed.

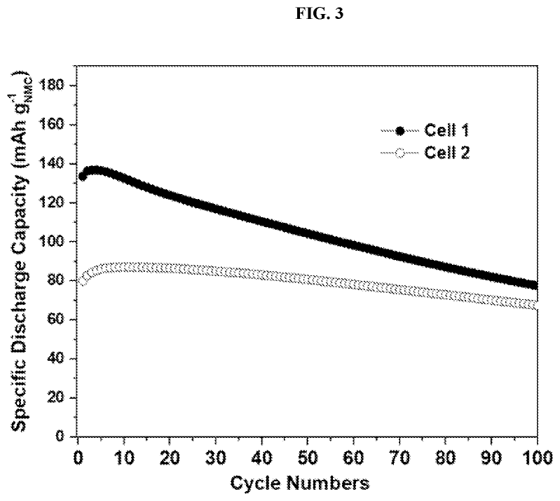

To demonstrate the advantages of the methods described herein, cycling performance of conventionally prepared electrodes (i.e. by directly mixing alkaline source material with cathode slurry) is provided in FIG. 3. Li₂O₂ was mixed with LiNi_{0.775}Mn_{0.2}Co_{0.05}O₂, C₄₅ conductive carbon, and a PVDF binder in a mass ratio of 2.5:87.5:5:5 to form a cathode slurry. The cathode slurry was cast on an aluminum current collector followed by 70° C. drying and 100° C. vacuum drying for 24 hours in total. The obtained cathode laminate is calendared and cut to size and assembled into cells. A baseline electrode, without Li₂O₂, was made by the same method, and the electrode contained LiNi_{0.775}Mn_{0.2}Co_{0.05}O₂, C₄₅ conductive carbon, and PVDF binder in a mass ratio of 90:5:5. The anode contained 15 wt % silicon and 73 wt % graphite. A representative cycling performance of LiNi_{0.775}Mn_{0.2}Co_{0.05}O₂ and Li₂O₂ cathode vs. Si-graphite composite anode is shown in FIG. 3. The electrolyte was 1.2 M LiPF₆ in a mixture of EC/EMC (3:7 by mass) with 10 wt. % FEC. The cells were cycled between 4.35 and 3V with constant current-constant voltage charging at C/3 with a cut-off current of C/10 or 3 hours at 50° C. Cell 1 did not contain Li₂O₂, but Cell 2 does contain it. The results demonstrate that directly mixing pure Li₂O₂ into cathode cannot help to improve the full cell performance.

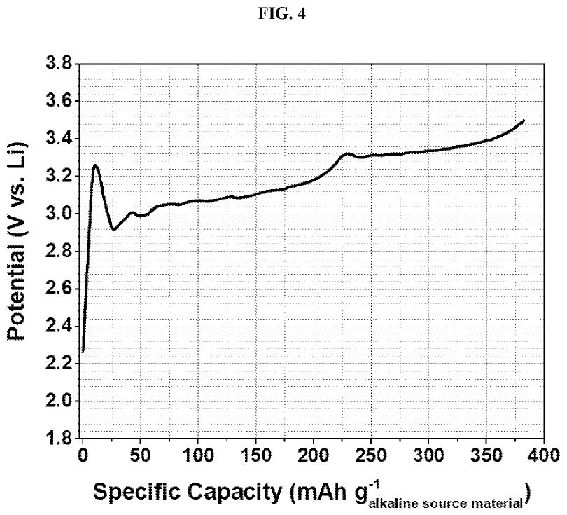

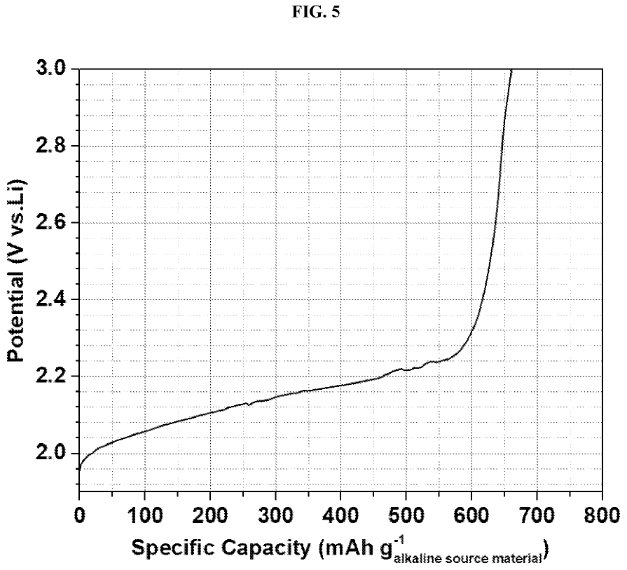

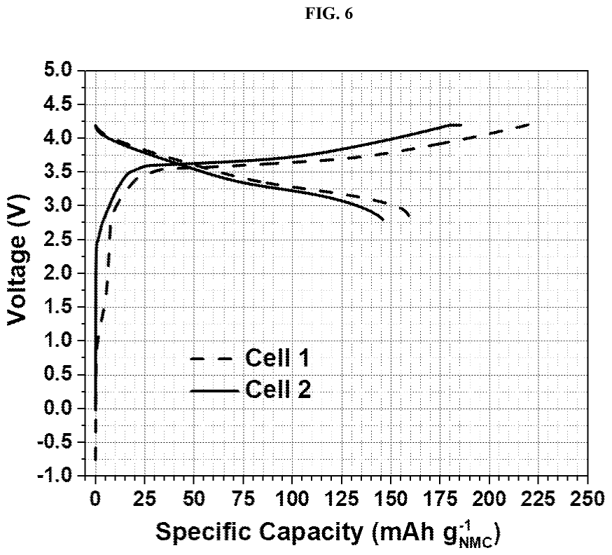

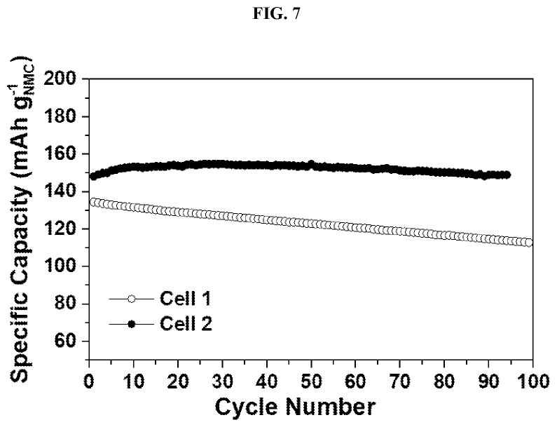

Example 2. Carbon-coated alkaline source material. This example shows that carbon coating of the alkaline source material can effectively improve the conductivity and chemical stability of the alkaline material. See FIGS. 4 and 5. Carbon-coated lithiated sulfur∥Li half-cell configuration in FIG. 5 and NMC622 (LiCo_{0.6}Mn_{0.2}Ni_{0.2}O₂)Si full cells in FIG. 6 and FIG. 7 (which delivers superior cycling performance with pre-lithiation) demonstrate that the carbon-coated alkaline source materials can be combined with a full cell containing lithium ion cathode materials, such as NMC622. In the case of lithiated sulfur, one way of incorporating lithiated sulfur in a carbon matrix is by reacting carbon-confined sulfur in a reactor that contains Li metal. The sulfur will react with lithium metal at temperatures above 180° C. to form Li₂S caged with carbon.

De-lithiation curves of pure lithiated sulfur and carbon-coated lithiated sulfur are shown in FIGS. 4 and 5. An electrode of pure lithiated sulfur was prepared by blending commercial lithiated sulfur with conductive carbon C65 and PVDF in NMP (N-methyl pyrrolidone) to form a slurry that was then cast on an aluminum current collector and dried at 100° C. under vacuum. The cathode contains 80 wt % commercial lithiated sulfur, 10 wt % C65, and 10 wt % PVDF. The cell was electrochemically activated in an electrolyte of 1 M LiTFSI (lithium trifluoromethansulfonimide) in DOL (dioxolane)/DME. A formation current of 0.02 mA/cm² was used, and the testing temperature was 25° C. The results show that without a carbon-coating the activation voltage needs to be higher than 3.5V, and the obtained charge capacity is less than 400 mAh/g.

FIG. 5 is a delithiation curve of a carbon-coated, lithiated sulfur. The carbon-coated lithiated sulfur was prepared by lithiating carbon-confined sulfur with a lithium-containing reagent, such as n-butyl lithium, at a molar ratio of 1:4. A mixture of carbon and sulfur was heated to 155° C. in argon (“Ar”) for 10 hours to form carbon-confined sulfur. The carbon-confined sulfur was further heat-treated at 200° C. in a stream of flowing argon for 6 hours to remove the sulfur deposited on the surface of carbon, then lithiate using n-butyl lithium at 100° C. The carbon cage was microporous, containing pore sizes of less than 1 nm. An electrode was prepared by blending carbon-confined lithiated sulfur with conductive carbon C65 and PVDF in NMP to form a slurry that was then cast on an aluminum current collector. The electrode was then dried at 100° C. under vacuum. The cathode contained 80 wt % carbon-coated lithiated sulfur, 10 wt % C65, and 10 wt % PVDF. The cell was electrochemically activated using an electrolyte of 1.2 M LiPF₆ in EC/EMC with 10 wt % FEC. The formation current was 0.02 mA/cm² and the cells are tested at 25° C. The results demonstrate that with carbon-coating, the activation potential was decreased to 3.0V, and the total charge capacity was increased to 650 mAh/g.

FIG. 6 is the first cycle charge and discharge curve of a full cells with a Li-ion cathode material LiCo_{0.6}Mn_{0.2}Ni_{0.2}O₂ in the laminate. The cathode of Cell 1 contained 90 wt % LiCo_{0.6}Mn_{0.2}Ni_{0.2}O₂, 5 wt % C65, and 5 wt % PVDF. The cathode of Cell 2 contained 80 wt % LiCo_{0.6}Mn_{0.2}Ni_{0.2}O₂, 10 wt % carbon-coated lithiated sulfur, 5 wt % C65, and 5 wt % PVDF in the slurry. The anode contained 70 wt % Si, 20 wt % C65, 10 wt % binder lithium substitute polyacrylic acid (Li-PAA). The electrolyte was 1.2M LiPF₆ in a mixture of EC and EMC (3/7) with 10 wt % FEC. The formation current was C/15 and the cells were cycled at 25° C. The results demonstrate that the carbon-coated alkaline source material can be successfully activated in a real cell. The increase of discharge capacity demonstrate that the carbon coating is a feasible method to activate alkaline source material compositing the activate lithium loss during the formation of solid electrolyte interface. This carbon-coating method clearly outperformed the non-coated alkaline source and mixing the alkaline source with carbon method, which led to unobservable increase in the initial specific capacity, in activating the pre-lithiation reagent.

FIG. 7 is a cycling performance of full cells with cathode material LiCo_{0.6}Mn_{0.2}Ni_{0.202} in the laminate. The cathode of Cell 1 contained 90 wt % LiCo_{0.6}Mn_{0.2}Ni_{0.202, 5} wt % C65, and 5 wt % PVDF. The cathode of Cell 2 contained 80 wt % LiCo_{0.6}Mn_{0.2}Ni_{0.2}O₂, 10 wt % carbon-coated lithiated sulfur, 5 wt % C65, and 5 wt % PVDF in the slurry. The anode contained 70 wt % Si, 20 wt % C65, and 10 wt % Li-PAA. The electrolyte was 1.2M LiPF₆ in a mixture of EC and EMC (3/7) with 10 wt % FEC. The cycling current was C/3 and cells were tested at 25° C. After 3 formation cycles at C/10 between 4.2V and 2.8V, Cells 1 and 2 were cycled between 4.2 and 2.8V at C/3. The cycling results demonstrate that the carbon-coated lithiated source material can be combined with a full cell to improve both capacity and cycling stability significantly. The results not only show the success of this pre-lithiation method in enhancing both specific capacity and capacity retention during cycling, but also unambiguously demonstrate the superiority of this new carbon-coating method over the traditional non-coating or mixing the alkaline source with carbon method in activating the pre-lithiation reagent.

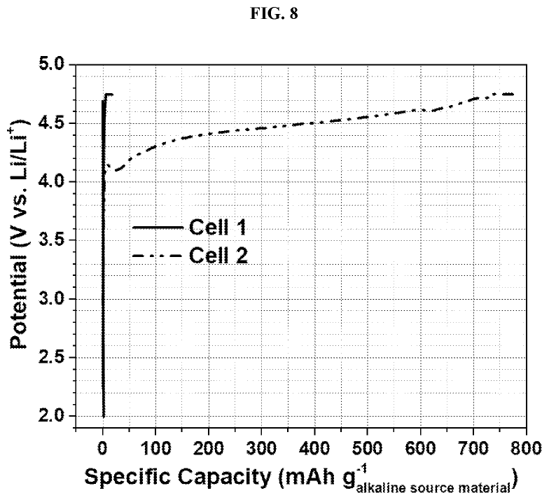

Example 3. Alkaline source-carbon-catalyst composite material. This example demonstrates that the alkaline source-carbon-catalyst composite materials can be used as a coating layer on top of a cathode to improve the full cell performance. Electrochemical activation of a pure alkaline source material, such as Li₂O₂, an alkaline source with conductive carbon, and an alkaline source with catalyst such as carbon nanotubes and iron nanoparticles, are shown in FIGS. 8-10. The results demonstrate the success of this method enabling alkaline source-carbon-catalyst composite in enhancing both specific capacity and capacity retention during cycling, and it also demonstrates that the method is superior to traditional mixing methods in activating the pre-lithiation reagent even at room temperature.

Pure Li₂O₂ was made by dispersing Li₂O₂ in dimethyl carbonate (DMC). The solid-to-liquid mass ratio in the as obtained suspension was 0.1. The prepared suspension was subjected to vigorous mechanical mixing before being spread on cathode laminate. The coating layer was dried at 85° C. and calendered prior to being assembled into the cell. A representative charging curve of the pure Li₂O₂ on an aluminum current collector is shown in FIG. 8. It shows that when Li₂O₂ is the only active alkaline-ion source on the top of cathode of the battery, a voltage as high as 4.7 V is necessary to activate 65% of alkaline source material (775 mAh/g in terms of theoretical capacity of 1168 mAh/g) with a current density of 0.02 mA/cm² at 25° C.

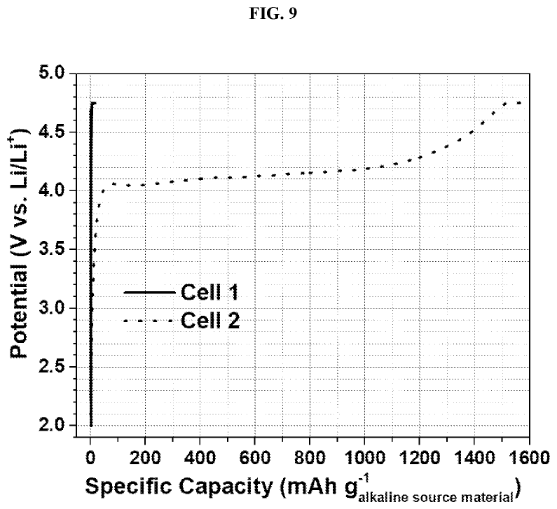

The method of spread coating enables the combination of alkaline source material with catalyst and conductive carbon. The activation potential under room temperature is further lowered by mixing a catalyst and/or conductive carbon with the alkaline source materials to make the coating layer on cathode. A typical coating reagent containing alkaline source-carbon-catalyst composite comprising Li₂O₂, conductive carbon C65, and carbon nanotube, which is made by mixing the materials in DMC with a mass ratio of 2:1:1. The solid-to-liquid mass ratio in the as-obtained suspension is 0.2. The prepared suspension was vigorously mechanically mixed prior to being spread on a cathode laminate. The coating layer was dried at 85° C. and calendered before being assembled into the cell. A representative charging curve of the Li₂O₂ with conductive carbon and carbon nanotube on an aluminum current collector is shown in FIG. 9. It shows that when adding conductive carbon and carbon nanotubes, the activation voltage of Li₂O₂ is decreased to 4.2 V, and nearly 100% of the alkaline source material (1100 mAh/g in terms of theoretical capacity of 1168 mAh/g) was activated with a current density of 0.02 mA/cm² at 25° C.

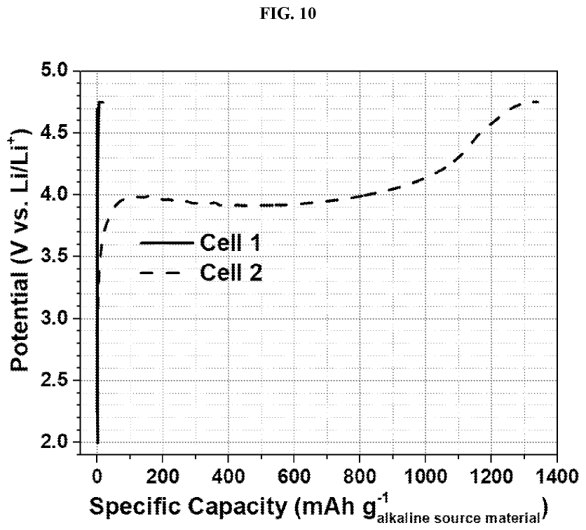

A typical coating reagent containing alkaline source-carbon-catalyst composite comprising Li₂O₂, conductive carbon C65, carbon nanotube, and iron catalyst, and was made by mixing the materials in DMC with a mass ratio of 2:1:0.5:0.5. The solid-to-liquid mass ratio in the as-obtained suspension was 0.2. The prepared suspension was subjected to vigorous mechanical mixing prior to being coated on cathode laminate. The coating layer was further dried at 85° C. and pressed before being assembled into the cell. A representative charging curve of the Li₂O₂ with conductive carbon, carbon nanotube and iron catalyst on an aluminum current collector is shown in FIG. 10. It clearly shows that when Li₂O₂ is the only active alkaline-ion source on the positive electrode of the battery, the activation voltage is decreased to 4.0 V to activate near 68% of alkaline source material (800 mAh/g in terms of theoretical capacity of 1168 mAh/g). Nearly 100% activation is achieved at a 4.2 V cut-off voltage with a current of 0.02 mA/cm² at 25° C.

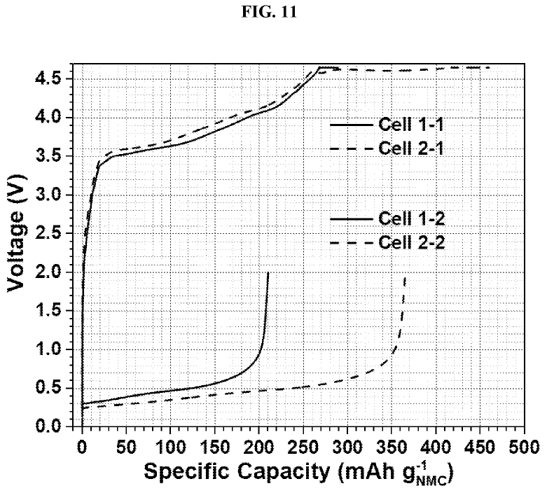

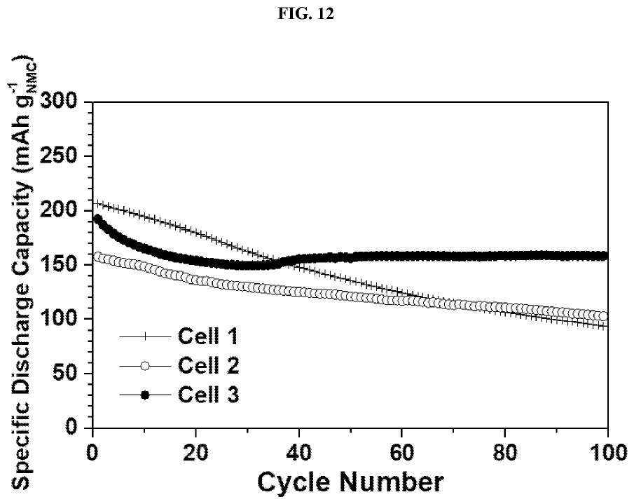

Full cells were made with a matched cathode and anode configuration. A full cell with silicon anode was charged to 4.65 V vs. Si with C/20 under 30° C. for the formation. The electrolyte was 1.2M LiPF₆ in a mixture of ethylene carbonate and ethyl methyl carbonate (EC/EMC; 3/7) with 10 wt % FEC. The NMC electrode was made of 90 wt % LiNi_{0.775}Mn_{0.2}Co_{0.05}O₂, 5 wt % Super P, and 5 wt % PVDF. About 0.5 mg Li₂O₂ is put on top of cathode laminate with the forementioned method and activated to compensate the lithium consumption of silicon-based anode materials once it is used in a full cell as shown in FIGS. 11 and 12. The results illustrate not only the success of this pre-lithiation method in enhancing both specific capacity and capacity retention during cycling, but also unambiguously demonstrate the superiority of this new method over the traditional mixing of alkaline source with carbon for activating the pre-lithiation reagent.

FIG. 12 illustrates a battery with cathode material LiNi_{0.775}Mn_{0.2}Co_{0.05}O₂ having a gradient composition in the laminate, and pure Li₂O₂ in the coating layer. The cathode contains 90 wt % LiNi_{0.775}Mn_{0.2}Co_{0.05}O₂, 5 wt % C65, and 5 wt % PVDF. The coating layer contains pure Li₂O₂. Anode contains 70 wt % Si, 20 wt % C65, and 10 wt % binder Li-PAA. The electrolyte was 1.2M LiPF₆ in a mixture of EC and EMC with 10 wt % FEC. The formation current was C/20 and cells were tested at 30° C. The results demonstrate that when combining the coating layer with a full cell, the alkaline source material is activated. The increase of the recovered cyclable lithium-ion from silicon anode demonstrates that the introduction of coating layer is a feasible method to activate the alkaline source material.

More importantly, the full cell cycling performance is improved with the coating layer. Cells 1 and 2 in FIG. 12 illustrate the cycling performance of the batteries with full gradient cathode material LiNi_{0.775}Mn_{0.2}Co_{0.05}O₂ in the laminate. Cell 3 is the battery having Li₂O₂ in the coating layer. The cathode contains 90 wt % LiNi_{0.775}Mn_{0.2}Co_{0.05}O₂, 5 wt % C65, and 5 wt % PVDF. The coating layer is made from the forementioned method containing pure Li₂O₂. The anode contains 70 wt % Si, 20 wt % C65, and 10 wt % Li-PAA. The electrolyte is 1.2M LiPF₆ in a mixture of EC and EMC with 10 wt % FEC. The cycling current is C/3 and cells are tested under 30° C. After 3 formation cycles between 4.65V-2.5V with C/20, Cells 1 and 3 were cycled between 4.35V-2.5V; whereas the upper cutoff voltage for Cell 2 during the formation cycles is 4.35V. The results demonstrate that the coating layer can be combined with a real cell to improve both capacity and cycling stability. Again, this new coating method clearly outperformed the traditional mixing of alkaline source, which led to no observable increase in the initial specific capacity, in activating the pre-lithiation reagent.

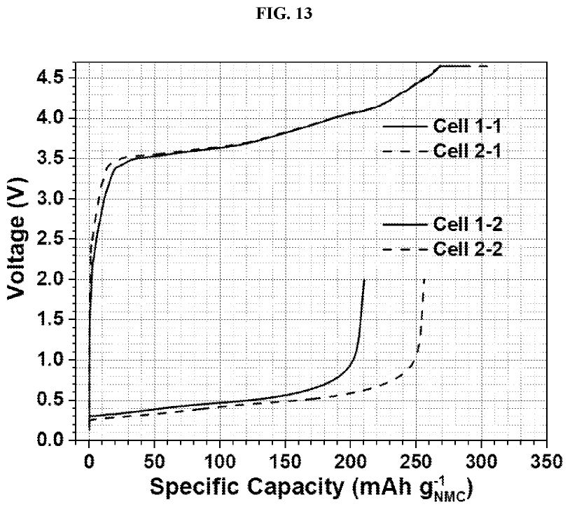

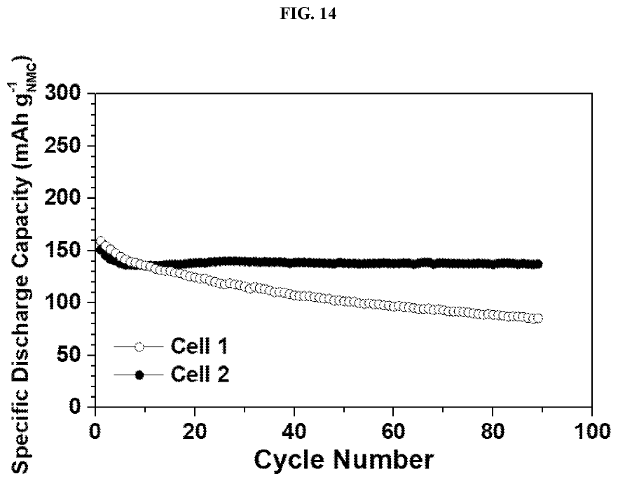

Full cells were then made with a matched cathode and anode configuration. A full cell with silicon anode is charged to 4.65 V vs. Si with C/20 under 25° C. for the formation. The electrolyte used was 1.2M LiPF₆ in a mixture of ethylene carbonate and ethyl methyl carbonate (EC/EMC) with 10 wt % FEC. The NMC electrode was made of 90 wt % LiNi_{0.775}Mn_{0.2}Co_{0.05}O₂, 5 wt % Super P, and 5 wt % PVDF. The alkaline source-carbon-catalyst composite contains about 0.5 mg Li₂O₂, 0.25 mg conductive carbon, and 0.25 mg carbon nanotube, and is coated top of cathode laminate. The increase of recovered lithium-ion and better cycling performance is due to the activation of Li₂O₂ which compensating the lithium consumption of the silicon-based anode materials as shown in FIGS. 13 and 14. The results display the success of the pre-lithiation method in enhancing both specific capacity and capacity retention during cycling.

FIG. 13 illustrates a battery with cathode material LiNi_{0.775}Mn_{0.2}Co_{0.05}O₂ having a gradient composition in the laminate and Li₂O₂ in the coating layer. The cathode contains 90 wt % LiNi_{0.775}Mn_{0.2}Co_{0.05}O₂, 5 wt % C65, and 5 wt % PVDF. The coating layer is made from the forementioned method containing 50 wt % Li₂O₂, 25 wt % C65, and 25 wt % carbon nanotube. The anode contains 70 wt % Si, 20 wt % C65, and 10 wt % Li-PAA. The electrolyte is 1.2M LiPF₆ in a mixture of EC and EMC with 10 wt % FEC. The formation current is C/20 and cells are tested under 30° C. The results demonstrate that the coating layer can be combined with a real cell and the alkaline source material can be successfully activated. The increase of the recovered cyclable lithium from silicon anode demonstrates that the conducting coating layer is a feasible method to activate alkaline source material.

Cell 1 in FIG. 14 is the cycling performance of real batteries with gradient cathode material LiNi_{0.775}Mn_{0.2}Co_{0.05}O₂ in the laminate. Cell 2 is the battery having Li₂O₂ and carbon nanotube in the coating layer. The cathode contains 90 wt % LiNi_{0.775}Mn_{0.2}Co_{0.05}O₂, 5 wt % C65, and 5 wt % PVDF. The coating layer is made from the forementioned method containing C65, carbon nanotube, and Li₂O₂. The anode contains 70 wt % Si, 20 wt % C65, 10 wt % Li-PAA. The electrolyte is 1.2M LiPF₆ in a mixture of EC and EMC with 10 wt % FEC. The cycling current is C/3 and cells are tested under 30° C. Cell 1 and 2 formed at 4.65 and cycled between 4.2 and 2.8V. The results demonstrate that the coating layer can be combined with a real cell to improve both capacity and cycling stability.

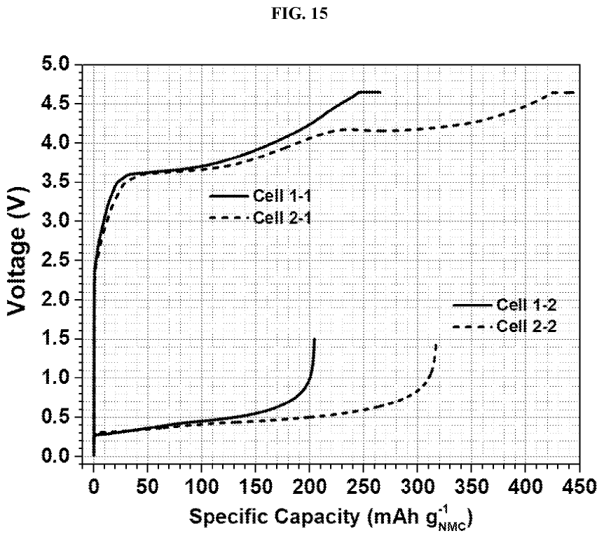

FIG. 15 is a battery with cathode material LiNi_{0.6}Mn_{0.2}Co_{0.2}O₂ in the laminate and Li₂O₂ in the coating layer. The cathode contains 90 wt % LiNi_{0.6}Mn_{0.2}Co_{0.2}O₂, 5 wt % C65, and 5 wt % PVDF. The coating layer is made from the forementioned method containing 50 wt % Li₂O₂, 25 wt % C65, and 12.5 wt % carbon nanotube and 12.5 wt % iron catalyst. The anode contains 70 wt % Si, 20 wt % C65, 10 wt % Li-PAA. The electrolyte is 1.2M LiPF₆ in a mixture of EC and EMC with 10 wt % FEC. The formation current is C/20 and cells are tested at 22° C. Cell 1 does not have the coating layer and cell 2 does. By comparing cell 1-1 and 2-1, it clearly shows that the coating layer can be combined with a real cell and the alkaline source material is successfully activated. The increase of the recovered cyclable lithium from silicon anode, as shown by cell 2-2 and 1-2, demonstrates that the conducting coating layer is a feasible method to activate alkaline source material.

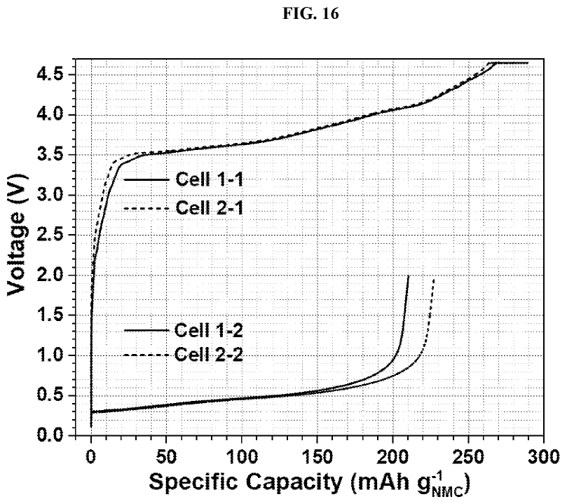

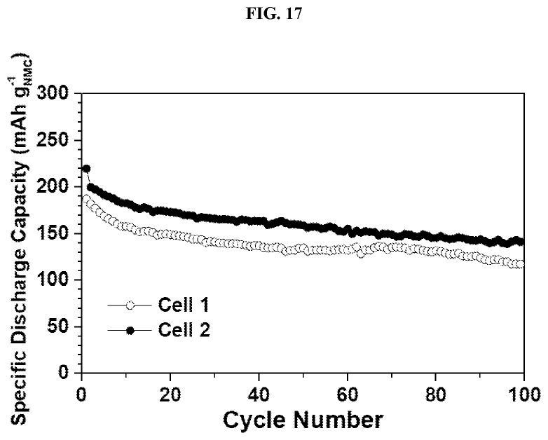

Example 4. Alkaline source material as electrolyte additive. Full cells are made with a matched cathode and anode configuration. A full cell with silicon anode is charged to 4.65 V vs. Si with C/20 under 30° C. in the formation cycles. The electrolyte used is 1.2M LiPF₆ in a mixture of ethylene carbonate and ethyl methyl carbonate (EC/EMC) with 10 wt % FEC with and without Li₂O₂. The NMC electrode is made of 90 wt % LiNi_{0.775}Mn_{0.2}Co_{0.05}O₂, 5 wt % Super P, and 5 wt % PVDF. About 2 wt % Li₂O₂ may be added into the electrolyte. After the activation of Li₂O₂, the increase of recovered cycleable lithium is observed, compensating the lithium consumption of silicon-based anode materials as shown in FIGS. 16 and 17. The results show the success of the pre-lithiation method in enhancing the specific capacity and capacity retention during cycling.

The battery has a gradient cathode material LiNi_{0.775}Mn_{0.2}Co_{0.05}O₂ in the laminate. The cathode contains 90 wt % LiNi_{0.775}Mn_{0.2}Co_{0.05}O₂, 5 wt % C65, and 5 wt % PVDF. The electrolyte of cell 1 is 1.2M LiPF₆ in a mixture of EC and EMC with 10 wt % FEC. The electrolyte of cell 2 contains 0.5 wt % Li₂O₂ dispersed in 1.2M LiPF₆ in a mixture of EC and EMC with 10 wt % FEC. The formation current is C/20 and the cells are tested under 30° C. The results demonstrate that the alkaline source material added into electrolyte can be successfully activated. The increase of recovered cyclable lithium from silicon anode demonstrates that the conducting coating layer is a feasible method to activate the alkaline source material.

FIG. 17 is the cycling performance of full cells with gradient cathode material LiNi_{0.775}Mn_{0.2}Co_{0.05}O₂ in the laminate. Cell 1 is using electrolyte 1.2M LiPF₆ in a mixture of EC and EMC with 10 wt % FEC. Cell 2 has the same electrolyte but with 2 wt % Li₂O₂. The cathode contains 90 wt % LiNi_{0.775}Mn_{0.2}Co_{0.05}O₂, 5 wt % C65, and 5 wt % PVDF. The anode contained 70 wt % Si, 20 wt % C65, and 10 wt % Li-PAA. The cycling current is C/3 and cells are tested under 30° C. The upper cutoff voltage for Cells 1 and 2 is 4.65V and the cells are cycled between 4.35V and 2.0V. The results demonstrate that the coating layer can be combined with a real cell to improve both capacity and cycling stability.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure. Other embodiments are set forth in the following claims.

What is claimed is:

1. A battery comprising:
a laminated cathode comprising:
a current collector;
a first layer comprising a cathode active material and a binder; and
a second layer deposited on the first layer, the second layer comprising a carbon-coated alkaline source material;
an anode;
a separator disposed between the anode and the laminated cathode; and
an electrolyte comprising a solvent and a salt.

2. The battery of claim 1, wherein the alkaline source material comprises Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, or a mixture of any two or more thereof.

3. The battery of claim 1, wherein the anode comprises a conductive carbon material, Li metal, Sb, Si, Si—C, SiO, Sn, tin oxide, Li₄Ti₅O₁₂, a composite tin alloy, a transition metal oxide, a lithium metal nitride, phosphorous, a phosphorous carbon composite, or a mixture of any two or more thereof.

4. The battery of claim 1, wherein the solvent is ethylene carbonate (EC), dimethyl carbonate (DMC), diethyl carbonate (DEC), propylene carbonate (PC), fluoroethylene carbonate (FEC), ethyl methyl carbonate (EMC), dioloxane, 7-butyrolactone, δ-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a N-alkylpyrrolidone, fluoro ether and fluoro esters, fluoroethylene carbonate, adiponitrile, or a mixture of any two or more thereof.

5. The battery of claim 4, wherein the solvent is FEC-DEC, FEC-EC-DEC, FEC-EMC, FEC-EC-EMC, EC-DMC, EC-DEC, EC-PC, EC-PC-DMC, EC-PC-DEC, or EC-DEC-DMC.

6. The battery of claim 1, wherein the salt is a lithium salt, a sodium salt, an ammonium salt, an alkylammonium salt, a lithium polysulfide, or a lithium polyselenide.

7. The battery of claim 1, wherein the alkaline source material is Li₂O₂, Li₂O₂ with carbon nanotube, or Li₂O₂ with carbon nanotubes and an iron catalyst.

8. The battery of claim 1, wherein the alkaline source material is Li₂O₂, Li₂O, lithiated sulfur, or mixture of any two or more.

9. The battery of claim 1, wherein the alkaline source material is Li₂O₂.

10. The battery of claim 1, wherein the alkaline source material is present in the laminate cathode from about 0.1 wt % to about 99 wt %.

11. A process for coating an alkaline source material, the process comprising:
contacting the alkaline source material with a carbon source to form a carbon-coated alkaline source material.

12. The process of claim 11, wherein the alkaline source material comprises Na₂O, Na₂O₂, NaO₂, Na₂S, Na₂Se, NaF, NaCl, NaBr, Li₂O, Li₂O₂, LiO₂, lithiated sulfur (including Li₂S), polysulfides, Li₂Se, polyselenides, LiF, LiCl, LiBr, or a mixture of any two or more thereof.

13. The process of claim 11, wherein the carbon source is a conductive carbon source and the contacting comprises (a) mixing of the alkaline source material with the conductive carbon source in a solvent or (b) introducing a gaseous hydrocarbon to the alkaline source material at elevated temperature, wherein the elevated temperature is sufficient to decompose the gaseous hydrocarbon to carbon that is then deposited on and around the alkaline source material.

14. The process of claim 13, wherein the contacting comprises (a) and the conductive carbon source comprises carbon nanotubes, carbon fiber, microporous carbon, mesoporous carbon, macroporous carbon, mesoporous microbeads, graphite, expandable graphite, polymer yield carbon, or carbon black.

15. The process of claim 13, wherein the contacting comprises (b) and the gaseous hydrocarbon comprises ethylene, propylene, toluene, or a mixture of any two or more thereof, and the elevated temperature is from about 150° C. to about 1000° C.

16. The process of claim 15, wherein the elevated temperature is from about 150° C. to about 450° C.

17. The process of claim 11, wherein the contacting the alkaline source material with the carbon source further includes contacting with a catalyst.

18. The process of claim 17, wherein the catalyst comprises a transition metal oxide, a non-precious metal, a precious metal, a metal alloy, or a mixture of any two or more thereof.

19. The process of claim 11, wherein the alkaline source material is Li₂O₂, Li₂O₂ with carbon nanotube, or Li₂O₂ with carbon nanotubes and an iron catalyst.

20. The process of claim 11, wherein the alkaline source material is Li₂O₂, Li₂O, lithiated sulfur, or mixture of any two or more.
